(19) United States
(12) Patent Application Publication
(10) Pub. No.: US 2026/0111240 A1
(43) Pub. Date: Apr. 23, 2026

(54) APPLICATION-SELECTIVE BATTERY STATE BASED API ACCESS PROHIBITION

(71) Applicant: TOYOTA JIDOSHA KABUSHIKI KAISHA, Aichi-ken (JP)

(72) Inventors: Yuichi YOSHIMURA, Kawasaki-shi (JP); Mitsuo DATE, Funabashi-shi (JP); Yutaka TARUOKA, Anjo-shi (JP)

(21) Appl. No.: 18/924,970

(22) Filed: Oct. 23, 2024

(51) Int. Cl. G06F 9/445; B60R 16/033; G07C 5/08

(52) U.S. Cl. CPC G06F 9/445; B60R 16/033; G07C 5/0808

(57) ABSTRACT

Application-selective battery state based API access prohibition is implemented by receiving a command to execute an application, determining whether the application is in a first group of applications, detecting whether a remaining capacity of a vehicle battery is equal to or less than a threshold value in response to determining that the application is not in the first group, and prohibiting the application from access to one or more Application Programming Interfaces (APIs) of the vehicle in response to detecting that the remaining capacity of the battery is equal to or less than the threshold value.

### BACKGROUND

A vehicle system is composed of many Electronic Controller Units (ECUs). Many ECUs are able to function as computers, with the ability to access externally-stored data and communicate through packet-based networks. Software applications are executed by ECUs to provide various services for the vehicle or a user thereof. Software applications request vehicle information through an Application Programming Interface (API).

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of a system for application-selective battery state based API access prohibition, according to at least some embodiments of the subject disclosure.

FIG. 2 is an operational flow for application-selective API access provision, according to at least some embodiments of the subject disclosure.

FIG. 3 is an operational flow for battery state based API access prohibition, according to at least some embodiments of the subject disclosure.

FIG. 4 is a block diagram of a hardware configuration for application-selective battery state based API access prohibition, according to at least some embodiments of the subject disclosure.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. In addition, the present disclosure may repeat reference numerals and/or letters in the various examples. This repetition is for the purpose of simplicity and clarity and does not in itself dictate a relationship between the various embodiments and/or configurations discussed.

Exposing APIs for access to vehicle data and vehicle control to different applications, such as Original Equipment Manufacturer (OEM) applications or third-party applications, raises a variety of risks. Managing such access to the APIs enables those risks to be reduced, mitigated, or avoided. Although various types of applications designed to be suitable for execution on the vehicle, certain applications are not suitable for execution while the battery has limited remaining capacity.

In at least some embodiments described herein, access to the vehicle APIs from a first group of applications is prohibited based on whether a remaining capacity of a vehicle battery is equal to or less than a threshold value. In at least some embodiments, the remaining capacity of the vehicle battery is detected based on the State of Charge (SoC) of the battery. In at least some embodiments, the first group of applications includes low priority applications.

In at least some embodiments, appropriately managing access from low-priority applications to the vehicle APIs based on the remaining capacity of the vehicle battery suppresses shortage of the battery capacity.

In at least some embodiments, applications that perform a vehicle operation, such as automatic valet parking, supporting vehicle platooning, etc. are provided API access, while a group of applications subject to battery state based API access includes applications that do not perform a vehicle operation, such as a music playback application. In at least some embodiments, whether or not the application involves vehicle operation, and thus is included in the group, is determined based on a history of vehicle API calls, authentication or classification results in an application store, analysis of binaries of the application, etc. In at least some embodiments, applications whose power consumption, such as averages of power consumption per unit of time or total power consumption during execution of the application, is less than a predetermined value are provided API access, while a group of applications subject to battery state based API access includes applications whose power consumption is equal to or more than the predetermined value. In at least some embodiments, the power consumption is calculated based on execution history of the application. In at least some embodiments, applications that have not called any APIs predetermined to be associated with high battery consumption, such as APIs that perform a vehicle operation, activation of air conditioning, outside communication, etc. are provided API access, while a group of applications subject to battery state based API access includes applications that have called any of the predetermined APIs.

In at least some embodiments, applications that perform emergency response, such as vehicle theft prevention, driver abnormality notification, infant abandonment prevention, etc. are provided API access, while a group of applications subject to battery state based API access includes other applications.

In at least some embodiments, each group is associated with a different threshold value. In at least some embodiments, the groups are ranked from higher SoC threshold to lower SoC threshold as a non-vehicle operation application group, a high power consumption application group, a high power API calling application group, and a non-emergency response application group.

In at least some embodiments, applications have predetermined group membership. In at least some embodiments, group membership is determined in real-time in response to receiving a command to execute an application, such as where the conditions are determined entirely by the vehicle, and the vehicle has sufficient computational resources to determine group membership. In at least some embodiments, as the amount of groups and associated thresholds increases, the likelihood of the vehicle having sufficient resources to determine group membership in real-time decreases.

In at least some embodiments, the threshold value of one or more groups are dynamic. In at least some embodiments, the threshold value of one or more groups is based on distance to destination. In at least some embodiments, the threshold value of one or more groups is customizable by the user.

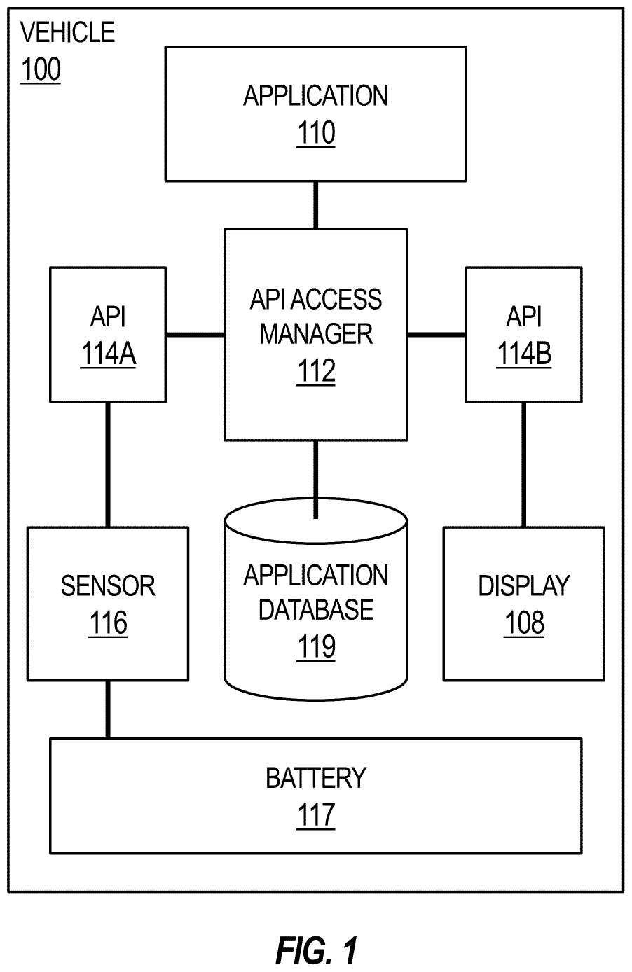

FIG. 1 is a schematic diagram of a system for application-selective battery state based API access prohibition, according to at least some embodiments of the subject disclosure. The system for application-selective battery state based API access prohibition includes vehicle 100, application 110, API access manager 112, API 114A and 114B, sensor 116, battery 117, application database 119, and display 108.

Vehicle 100 is a component of a system for application-selective battery state based API access prohibition. In at least some embodiments, vehicle 100 is a car, a truck, an electric vehicle, an autonomous vehicle, etc. In at least some embodiments, vehicle 100 is used for personal transportation, commercial transportation, logistics, or any other transportation needs. In at least some embodiments, vehicle 100 is configured for transportation, navigation, safety features, etc. In at least some embodiments, vehicle 100 interacts with various sensors, infotainment systems, user inputs, or any other vehicle systems. In at least some embodiments, vehicle 100 is configured to host ECUs and APIs, provide vehicle data, execute applications, etc.

Application 110 is a component of a system for application-selective battery state based API access prohibition. In at least some embodiments, application 110 is of the type including mobile apps, embedded software, cloud-based applications, etc. In at least some embodiments, application 110 is used for navigation, infotainment, diagnostics, or any other vehicle-related use. In at least some embodiments, application 110 is configured to provide user services, enhance vehicle functionality, etc. In at least some embodiments, application 110 interacts with operating systems, cloud services, user inputs, or any other application-related systems. In at least some embodiments, application 110 is configured to request vehicle data, execute specific tasks based on vehicle data, etc. In at least some embodiments, application 110 interacts with API access manager 112, API 114A and API 114B, as well as other vehicle components through API 114A and API 114B.

API access manager 112 is a component of a system for application-selective battery state based API access prohibition. In at least some embodiments, API access manager 112 is of the type including middleware, security software, access control systems, etc. In at least some embodiments, API access manager 112 is used for network security, data management, access control, or any other API management uses. In at least some embodiments, API access manager 112 is configured for security management, data access control, policy enforcement, etc. In at least some embodiments, API access manager 112 interacts with security systems, databases, system health monitors, or any other API-related systems. In at least some embodiments, API access manager 112 is configured to manage API access, such as access through API 114A and API 114B, enforce access policies, monitor battery state, etc. In at least some embodiments, API access manager 112 interacts with application 110, API 114A and API 114B, and application database 119.

API 114A and API 114B are components of a system for application-selective battery state based API access prohibition. In at least some embodiments, API 114A and API 114B are RESTful APIs, SOAP APIs, GraphQL APIs, etc. In at least some embodiments, API 114A and API 114B are used for web services, mobile apps, enterprise systems, or any other data exchange needs. In at least some embodiments, API 114A and API 114B are configured for data exchange, service provision, etc. In at least some embodiments, API 114A and API 114B interact with various applications, sensors, peripherals, etc. In at least some embodiments, API 114A and 114B are configured to provide vehicle data, allow control commands, etc. In at least some embodiments, API 114A and 114B interact with application 110, API access manager 112, sensor 116, and display 118.

Sensor 116 is a component of a system for application-selective battery state based API access prohibition. In at least some embodiments, sensor 116 is of the type including battery sensors, temperature sensors, pressure sensors, etc. In at least some embodiments, sensor 116 is of the type used in automotive systems, industrial automation, environmental monitoring, or any other data collection needs. In at least some embodiments, sensor 116 is configured for data collection, environmental monitoring, etc. In at least some embodiments, sensor 116 interacts with control units, data loggers, system feedback mechanisms, or any other sensor-related systems. In at least some embodiments, sensor 116 is configured to detect battery state, such as SoC or other indicators of remaining capacity, provide real-time data, etc. In at least some embodiments, sensor 116 interacts with API access manager 112, API 114A, and battery 117, as well as other vehicle components through API 114A.

Battery 117 is a component of a system for application-selective battery state based API access prohibition. In at least some embodiments, battery 117 is of the type including lithium-ion batteries, lead-acid batteries, solid-state batteries, etc. In at least some embodiments, battery 117 is of the type used in electric vehicles, renewable energy storage, consumer electronics, or any other energy storage needs. In at least some embodiments, battery 117 is configured for energy storage, power supply, etc. In at least some embodiments, battery 117 interacts with charging systems, power management systems, a vehicle engine, or any other battery-related systems. In at least some embodiments, battery 117 is configured to provide power, monitor SoC, etc. In at least some embodiments, battery 117 interacts with sensor 116.

Application database 119 is a component of a system for application-selective battery state based API access prohibition. In at least some embodiments, application database 119 is of the type including SQL databases, NoSQL databases, cloud storage solutions, etc. In at least some embodiments, application database 119 is used for mobile data management, mobile applications, or any other data storage needs. In at least some embodiments, application database 119 is configured for data storage, data retrieval, data management, etc. In at least some embodiments, application database 119 interacts with database management systems, applications, data access mechanisms, or any other database-related systems. In at least some embodiments, application database 119 is configured to store application data, maintain access policies, log application usage, etc. In at least some embodiments, application database 119 interacts with API access manager 112 and application 110.

Display 108 is a component of a system for application-selective battery state based API access prohibition. In at least some embodiments, display 108 is of the type including LCD screens, OLED displays, touchscreens, etc. In at least some embodiments, display 108 is usable in infotainment systems, navigation systems, control panels, or any other information display needs. In at least some embodiments, display 108 is configured as a user interface, an information display, a media player, etc. In at least some embodiments, display 108 interacts with control units, user inputs, visual feedback mechanisms, or any other display-related systems. In at least some embodiments, display 108 is configured to show battery status, display application access status, etc. In at least some embodiments, display 108 interacts with API access manager 112 and API 114B, as well as other vehicle components through API 114B.

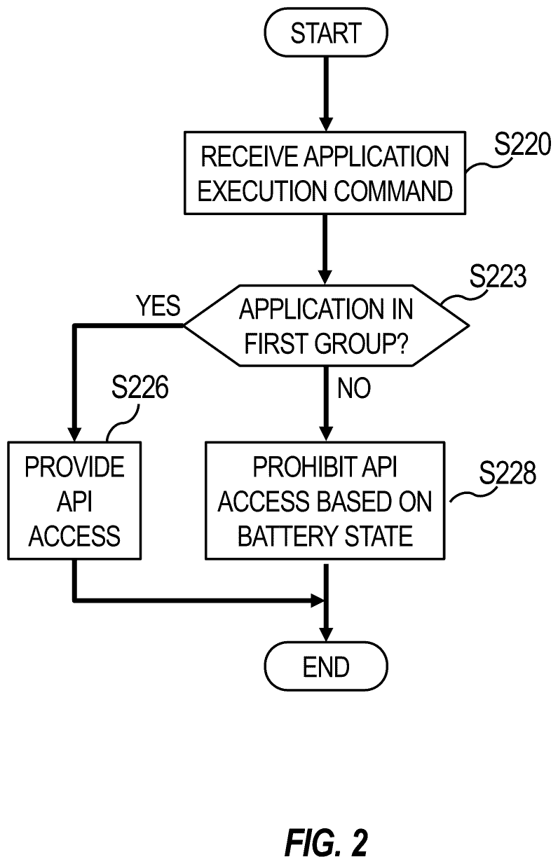

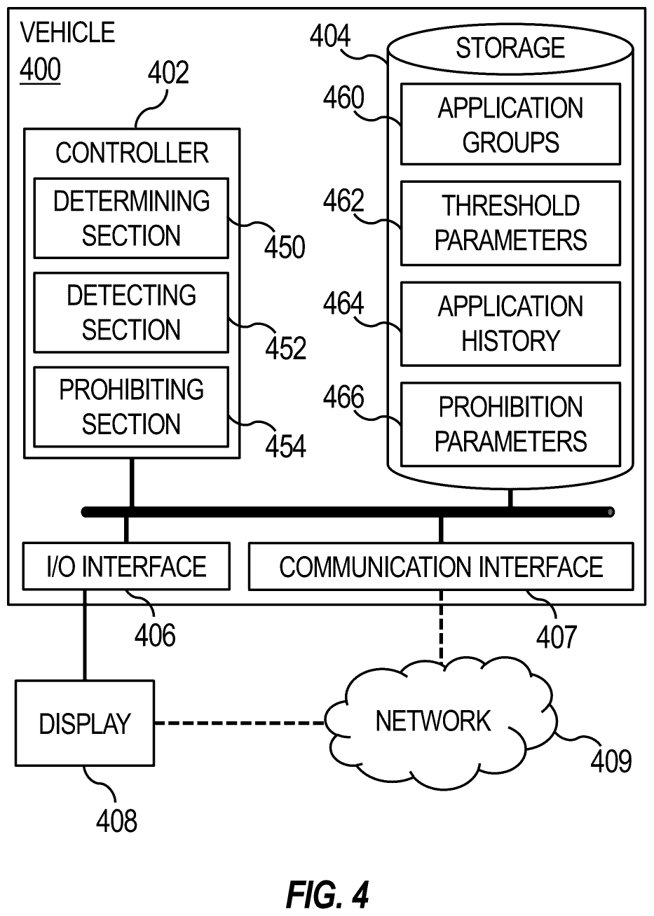

FIG. 2 is an operational flow for application-selective API access provision, according to at least some embodiments of the subject disclosure. In at least some embodiments, the operational flow provides a method of application-selective API access provision. In at least some embodiments, the method is performed by a controller of a vehicle, such as controller 402 of vehicle 400 of FIG. 4, described hereinafter.

At S220, the controller or a section thereof receives an application execution command. In at least some embodiments, the controller receives a command to execute an application, such as application 110 of FIG. 1. In at least some embodiments, the controller listens for incoming commands, parses the command details, and validates the command's authenticity. In at least some embodiments, the controller utilizes a command buffer to temporarily store the incoming command, authentication tokens to verify the command's legitimacy, and a command parser to interpret the command's structure. In at least some embodiments, the command data is in binary or JSON/XML format, and the tokens are in string format.

At S223, the controller or a section thereof determines whether the application is in the first group. In response to determining that the application is in the first group, the controller proceeds to API access provision at S226. In response to determining that the application is not in the first group, the controller proceeds to battery state based API access prohibition at S228. In at least some embodiments, the controller determines whether the application is in the first group of applications. In at least some embodiments, the first group of applications includes a plurality of applications that perform vehicle operation. In at least some embodiments, the controller determines whether the application performs a vehicle operation based on at least one of a history of vehicle API calls, an authentication or classification result in an application store, or a binary of the application. In at least some embodiments, the first group of applications includes a plurality of applications whose power consumption is less than a predetermined value. In at least some embodiments, the controller determines whether the power consumption of the application is less than the predetermined value. In at least some embodiments, the controller determines the power consumption of the application based on an execution history of the application. In at least some embodiments, the first group of applications includes a plurality of applications that have not accessed at least one API associated with increased power consumption. In at least some embodiments, the at least one API is among a plurality of APIs associated with increased power consumption. In at least some embodiments, the first group of applications includes a plurality of applications that perform emergency response. In at least some embodiments, the controller retrieves the application's metadata, checks the application's group classification, and compares it with a predefined group list. In at least some embodiments, the controller uses an application metadata store to access the necessary information, group classification rules to determine the application's category, and a predefined group list for comparison. In at least some embodiments, the metadata records, rule sets, and group lists are stored in an application database, such as application database 119 of FIG. 1.

At S226, the controller or a section thereof provides API access. In at least some embodiments, the controller provides API access to the application. In at least some embodiments, the controller authenticates the application, grants API access tokens, and logs the access event. In at least some embodiments, the controller relies on an API access control list to manage permissions, an authentication server to verify the application's identity, and access logs to record the event.

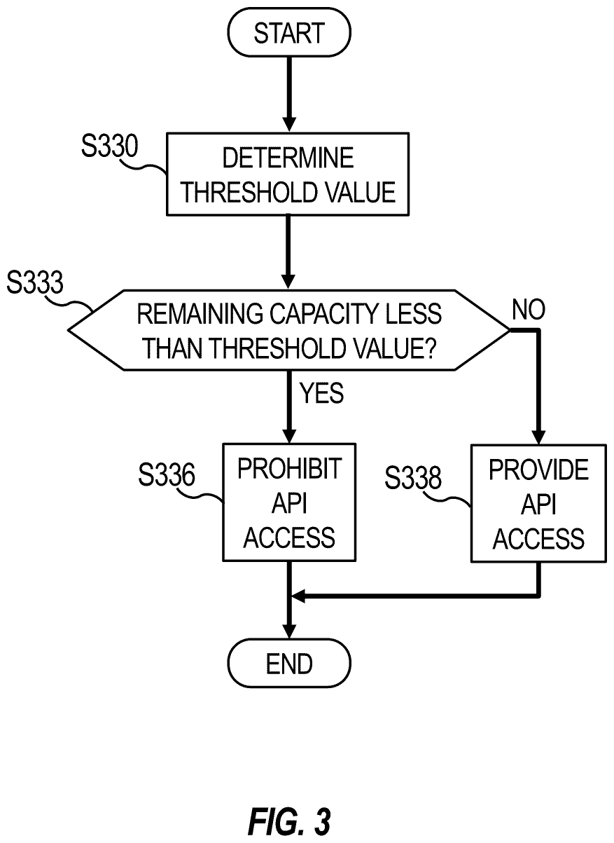

At S228, the controller or a section thereof prohibits API access based on the battery state. In at least some embodiments, the controller retrieves the current battery state, compares a remaining capacity with a threshold, denies API access in response to the remaining capacity being equal to or less than the threshold, and logs the prohibition event. In at least some embodiments, the controller performs functions such as reading the battery state, comparing values, denying access, and writing logs. In at least some embodiments, the controller prevents low-priority applications from accessing APIs when the battery capacity is low, improving efficiency of battery usage. In at least some embodiments, the controller performs the operational flow of FIG. 3, described hereinafter.

In the embodiment of FIG. 2, the controller determines whether the application is in a first group, and provides API access in response to determining that the application is in the first group. In at least some embodiments, the controller further determines whether the application is in a second group, and proceeds to battery state based API access prohibition in response to determining that the application is in the second group.

FIG. 3 is an operational flow for battery state based API access prohibition, according to at least some embodiments of the subject disclosure. In at least some embodiments, the operational flow provides a method of battery state based API access prohibition. In at least some embodiments, the method is performed by a controller of a vehicle, such as controller 402 of vehicle 400 of FIG. 4, described hereinafter.

At S330, the controller or a section thereof determines the threshold value. In at least some embodiments, the controller determines the threshold value by retrieving application priority, average power consumption, distance to the destination, or other bases upon which to compute the threshold value. In at least some embodiments, the controller utilizes a battery management system, application metadata, and a navigation system. In at least some embodiments, the controller produces the threshold value. In at least some embodiments, controller varies the relative weight of application priority, average power consumption, and distance to the destination on the threshold value. In at least some embodiments, the controller determines the threshold value based on the group of applications. In at least some embodiments, the controller determines the threshold value based on a distance to a destination of the vehicle. In at least some embodiments, the controller determines the threshold value based on an average power consumption of the plurality of applications in the first group of applications. In at least some embodiments, the controller determines the threshold value based on a priority level of the first group of applications. In at least some embodiments, the controller determines the threshold value according to the following formula:

$${V}_{TH} = f ( G , D , {P}_{A} , {P}_{G} )$$

where V_{TH} is the threshold value, G is the group of applications, D is the distance to destination, P_{A} is the average power consumption, and P_{G} is the priority level of the group of applications.

At S333, the controller or a section thereof determines whether the remaining battery capacity is less than the threshold value. In response to determining that the remaining battery capacity is less than the threshold value, the controller proceeds to API access prohibition at S336. In response to determining that the remaining battery capacity is not less than the threshold value, the controller proceeds to API access provision at S338. In at least some embodiments, the controller detects whether a remaining capacity of a vehicle battery is equal to or less than a threshold value in response to determining that the application is not in the first group. In at least some embodiments, the controller determines whether the remaining battery capacity is less than the threshold value by comparing the SoC with the threshold value. In at least some embodiments, the controller produces a boolean result, such as true or false. In at least some embodiments, the controller detects whether a remaining capacity of a vehicle battery is equal to or less than a second threshold value in response to determining that the application is in the second group.

At S336, the controller or a section thereof provides API access. In at least some embodiments, the controller provides API access by granting API access and logging the access event. In at least some embodiments, controller performs similarly to API access provision at S226 of FIG. 2.

At S338, the controller or a section thereof prohibits API access. In at least some embodiments, the controller prohibits the application from access to one or more APIs of the vehicle in response to detecting that the remaining capacity of the battery is equal to or less than the threshold value. In at least some embodiments, the controller prohibits API access by denying API access and logging the prohibition event. In at least some embodiments, the controller transmits an access denied message to the application.

FIG. 4 is a block diagram of a hardware configuration for application-selective battery state based API access prohibition, according to at least some embodiments of the subject disclosure. The hardware configuration includes vehicle 400, which interacts with display 408 directly or through network 409. In at least some embodiments, display 408 is a touch screen, a microphone, a camera, or any other device configured to detect tactile, aural, visual, etc. input. In at least some embodiments, network 409 is an ethernet network, a Controller Area Network (CAN), or any other wired or wireless network or a combination thereof. In at least some embodiments, vehicle 400 is a computer or other computing device that receives input or commands from display 408. In at least some embodiments, vehicle 400 is integrated with display 408. In at least some embodiments, vehicle 400 is a computer system that executes computer-readable instructions to perform operations for application-selective battery state based API access prohibition.

Vehicle 400 includes controller 402, storage 404, input/output interface 406, and communication interface 407. In at least some embodiments, controller 402 includes a processor or programmable circuitry executing instructions to cause the processor or programmable circuitry to perform operations according to the instructions. In at least some embodiments, controller 402 includes analog or digital programmable circuitry, or any combination thereof. In at least some embodiments, controller 402 includes physically separated storage or circuitry that interacts through communication. In at least some embodiments, storage 404 includes a non-volatile computer-readable medium capable of storing executable and non-executable data for access by controller 402 during execution of the instructions. In at least some embodiments, communication interface 407 transmits and receives data from network 409. In at least some embodiments, input/output interface 406 connects to various input and output units, such as display 408, via a parallel port, a serial port, a keyboard port, a mouse port, a monitor port, and the like to accept commands and present information. In some embodiments, storage 404 is external from vehicle 400.

Controller 402 includes determining section 450, detecting section 452, and prohibiting section 454. storage 404 includes application groups 460, threshold parameters 462, application history 464, and prohibition parameters 466.

Determining section 450 is the circuitry or instructions of controller 402 configured for determining application group membership. In at least some embodiments, determining section 450 is configured to determine whether the application is in a first group of applications. In at least some embodiments, determining section 450 utilizes storage 404 to read or record information, such as application groups 460. In at least some embodiments, determining section 450 includes sub-sections for performing additional functions, as described in the foregoing flow charts. In at least some embodiments, such sub-sections are referred to by a name associated with a corresponding function.

Detecting section 452 is the circuitry or instructions of controller 402 configured for remaining battery capacity detection. In at least some embodiments, detecting section 452 is configured to detect whether a remaining capacity of a vehicle battery is equal to or less than a threshold value in response to determining that the application is in the first group. In at least some embodiments, detecting section 452 utilizes storage 404 to read or record information, such as threshold parameters 462 and application history 464. In at least some embodiments, detecting section 452 includes sub-sections for performing additional functions, as described in the foregoing flow charts. In at least some embodiments, such sub-sections are referred to by a name associated with a corresponding function.

Prohibiting section 454 is the circuitry or instructions of controller 402 configured for API access prohibition. In at least some embodiments, prohibiting section 454 is configured to prohibit an application from access to one or more APIs of the vehicle in response to detecting that the remaining capacity of the battery is equal to or less than the threshold value. In at least some embodiments, prohibiting section 454 utilizes storage 404 to read or record information, such as prohibition parameters 466. In at least some embodiments, prohibiting section 454 includes sub-sections for performing additional functions, as described in the foregoing flow charts. In at least some embodiments, such sub-sections are referred to by a name associated with a corresponding function.

In at least some embodiments, the vehicle is another device capable of processing logical functions in order to perform the operations herein. In at least some embodiments, the controller and the storage need not be entirely separate devices, but share circuitry or one or more computer-readable mediums. In at least some embodiments, the storage includes a hard drive storing both the computer-executable instructions and the data accessed by the controller, and the controller includes a combination of a central processing unit (CPU) and RAM, in which the computer-executable instructions are able to be copied in whole or in part for execution by the CPU during performance of the operations herein.

In at least some embodiments where the vehicle is a computer, a program that is installed in the computer is capable of causing the computer to function as or perform operations associated with apparatuses of the embodiments described herein. In at least some embodiments, such a program is executable by a processor to cause the computer to perform certain operations associated with some or all of the blocks of flowcharts and block diagrams described herein.

At least some embodiments are described with reference to flowcharts and block diagrams whose blocks represent (1) steps of processes in which operations are performed or (2) sections of hardware responsible for performing operations. In at least some embodiments, certain steps and sections are implemented by dedicated circuitry, programmable circuitry supplied with computer-readable instructions stored on computer-readable media, and/or processors supplied with computer-readable instructions stored on computer-readable media. In at least some embodiments, dedicated circuitry includes digital and/or analog hardware circuits and include integrated circuits (IC) and/or discrete circuits. In at least some embodiments, programmable circuitry includes reconfigurable hardware circuits comprising logical AND, OR, XOR, NAND, NOR, and other logical operations, flip-flops, registers, memory elements, etc., such as field-programmable gate arrays (FPGA), programmable logic arrays (PLA), etc.

In at least some embodiments, the computer-readable medium includes a tangible device that is able to retain and store instructions for use by an instruction execution device. In some embodiments, the computer-readable medium includes, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

While embodiments of the present invention have been described, the technical scope of any subject matter claimed is not limited to the above described embodiments. Persons skilled in the art would understand that various alterations and improvements to the above-described embodiments are possible. Persons skilled in the art would also understand from the scope of the claims that the embodiments added with such alterations or improvements are included in the technical scope of the invention.

The operations, procedures, steps, and stages of each process performed by an apparatus, system, program, and method shown in the claims, embodiments, or diagrams are able to be performed in any order as long as the order is not indicated by “prior to,” “before,” or the like and as long as the output from a previous process is not used in a later process. Even if the process flow is described using phrases such as “first” or “next” in the claims, embodiments, or diagrams, such a description does not necessarily mean that the processes must be performed in the described order.

Application-selective battery state based API access prohibition is implemented by receiving a command to execute an application, determining whether the application is in a first group of applications, detecting whether a remaining capacity of a vehicle battery is equal to or less than a threshold value in response to determining that the application is not in the first group, and prohibiting the application from access to one or more Application Programming Interfaces (APIs) of the vehicle in response to detecting that the remaining capacity of the battery is equal to or less than the threshold value.

In at least some embodiments, the first group of applications includes a plurality of applications that perform vehicle operation. In at least some embodiments, application-selective battery state based API access prohibition is further implemented by determining whether the application performs a vehicle operation based on at least one of a history of vehicle API calls, an authentication or classification result in an application store, or a binary of the application. In at least some embodiments, the first group of applications includes a plurality of applications whose power consumption is less than a predetermined value. In at least some embodiments, application-selective battery state based API access prohibition is further implemented by determining whether the power consumption of the application is less than the predetermined value. In at least some embodiments, application-selective battery state based API access prohibition is further implemented by determining the power consumption of the application based on an execution history of the application. In at least some embodiments, the first group of applications includes a plurality of applications that have not accessed at least one API associated with increased power consumption. In at least some embodiments, the at least one API is among a plurality of APIs associated with increased power consumption. In at least some embodiments, the first group of applications includes a plurality of applications that perform emergency response. In at least some embodiments, application-selective battery state based API access prohibition is further implemented by determining whether the application is in a second group; and detecting whether a remaining capacity of a vehicle battery is equal to or less than a second threshold value in response to determining that the application is in the second group. In at least some embodiments, application-selective battery state based API access prohibition is further implemented by determining the threshold value based on a distance to a destination of the vehicle. In at least some embodiments, application-selective battery state based API access prohibition is further implemented by determining the threshold value based on an average power consumption of the plurality of applications in the first group of applications. In at least some embodiments, application-selective battery state based API access prohibition is further implemented by determining the threshold value based on a priority level of the first group of applications.

Application-selective battery state based API access prohibition is implemented by receiving a command to execute an application, determining whether the application is in a first group of applications, detecting whether a remaining capacity of a vehicle battery is equal to or less than a threshold value in response to determining that the application is not in the first group, and prohibiting the application from access to one or more Application Programming Interfaces (APIs) of the vehicle in response to detecting that the remaining capacity of the battery is equal to or less than the threshold value.

In at least some embodiments, the first group of applications includes a plurality of applications that perform vehicle operation. In at least some embodiments, application-selective battery state based API access prohibition further includes determining whether the application is in a second group, and detecting whether a remaining capacity of a vehicle battery is equal to or less than a second threshold value in response to determining that the application is in the second group. In at least some embodiments, application-selective battery state based API access prohibition is further implemented by determining the threshold value based on a distance to a destination of the vehicle.

Application-selective battery state based API access prohibition is implemented by receiving a command to execute an application, determining whether the application is in a first group of applications, detecting whether a remaining capacity of a vehicle battery is equal to or less than a threshold value in response to determining that the application is not in the first group, and prohibiting the application from access to one or more Application Programming Interfaces (APIs) of the vehicle in response to detecting that the remaining capacity of the battery is equal to or less than the threshold value.

In at least some embodiments, the first group of applications includes a plurality of applications that perform vehicle operation. In at least some embodiments, application-selective battery state based API access prohibition further includes determining whether the application is in a second group; and detecting whether a remaining capacity of a vehicle battery is equal to or less than a second threshold value in response to determining that the application is in the second group.

The foregoing outlines features of several embodiments so that those skilled in the art would better understand the aspects of the present disclosure. Those skilled in the art should appreciate that this disclosure is readily usable as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that various changes, substitutions, and alterations herein are possible without departing from the spirit and scope of the present disclosure.

What is claimed is:

1. A non-transitory computer-readable medium including instructions that, in response to execution by one or more processors, cause performance of operations comprising:
receiving a command to execute an application;
determining whether the application is in a first group of applications;
detecting whether a remaining capacity of a vehicle battery is equal to or less than a threshold value in response to determining that the application is not in the first group; and
prohibiting the application from access to one or more Application Programming Interfaces (APIs) of the vehicle in response to detecting that the remaining capacity of the battery is equal to or less than the threshold value.

2. The computer-readable medium of claim 1, wherein the first group of applications includes a plurality of applications that perform vehicle operation.

3. The computer-readable medium of claim 2, further comprising determining whether the application performs a vehicle operation based on at least one of a history of vehicle API calls, an authentication or classification result in an application store, or a binary of the application.

4. The computer-readable medium of claim 1, wherein the first group of applications includes a plurality of applications whose power consumption is less than a predetermined value.

5. The computer-readable medium of claim 4, further comprising determining whether the power consumption of the application is less than the predetermined value.

6. The computer-readable medium of claim 5, further comprising determining the power consumption of the application based on an execution history of the application.

7. The computer-readable medium of claim 1, wherein the first group of applications includes a plurality of applications that have not accessed at least one API associated with increased power consumption.

8. The computer-readable medium of claim 7, wherein the at least one API is among a plurality of APIs associated with increased power consumption.

9. The computer-readable medium of claim 1, wherein the first group of applications includes a plurality of applications that perform emergency response.

10. The computer-readable medium of claim 1, further comprising
determining whether the application is in a second group; and
detecting whether a remaining capacity of a vehicle battery is equal to or less than a second threshold value in response to determining that the application is in the second group.

11. The computer-readable medium of claim 1, further comprising
determining the threshold value based on a distance to a destination of the vehicle.

12. The computer-readable medium of claim 1, further comprising
determining the threshold value based on an average power consumption of the plurality of applications in the first group of applications.

13. The computer-readable medium of claim 1, further comprising
determining the threshold value based on a priority level of the first group of applications.

14. A method comprising:
receiving a command to execute an application;
determining whether the application is in a first group of applications;
detecting whether a remaining capacity of a vehicle battery is equal to or less than a threshold value in response to determining that the application is not in the first group; and
prohibiting the application from access to one or more Application Programming Interfaces (APIs) of the vehicle in response to detecting that the remaining capacity of the battery is equal to or less than the threshold value.

15. The method of claim 14, wherein the first group of applications includes a plurality of applications that perform vehicle operation.

16. The method of claim 14, further comprising
determining whether the application is in a second group; and
detecting whether a remaining capacity of a vehicle battery is equal to or less than a second threshold value in response to determining that the application is in the second group.

17. The method of claim 14, further comprising
determining the threshold value based on a distance to a destination of the vehicle.

18. A device comprising:
receiving a command to execute an application,
determining whether the application is in a first group of applications,
detecting whether a remaining capacity of a vehicle battery is equal to or less than a threshold value in response to determining that the application is not in the first group, and
prohibiting the application from access to one or more Application Programming Interfaces (APIs) of the vehicle in response to detecting that the remaining capacity of the battery is equal to or less than the threshold value.

19. The device of claim 18, wherein the first group of applications includes a plurality of applications that perform vehicle operation.

20. The device of claim 18, further comprising
determining whether the application is in a second group; and
detecting whether a remaining capacity of a vehicle battery is equal to or less than a second threshold value in response to determining that the application is in the second group.
